(19) United States
(12) Patent Application Publication
(10) Pub. No.: US 2023/0168026 A1
(43) Pub. Date: Jun. 1, 2023

(54) REFRIGERATOR

(71) Applicant: LG ELECTRONICS INC., Seoul (KR)

(72) Inventor: Minki KIM, Seoul (KR)

(21) Appl. No.: 17/788,499

(22) PCT Filed: Nov. 30, 2020
(86) PCT No.: PCT/KR2020/017283

§ 371 Date: Feb. 1, 2023

(30) Foreign Application Priority Data
Dec. 24, 2019 (KR) 10-2019-0174469

(51) Int. Cl. F25D 27/00; F25D 29/00; F21V 19/00; F25D 23/02

(52) U.S. Cl. CPC F25D 27/00; F25D 29/005; F21V 19/003; F25D 23/028; F25D 2327/001; F25D 2400/18; F25D 2400/36

(57) ABSTRACT

A refrigerator according to an embodiment of the present disclosure includes a main body forming a storage space with an open front; a door configured to open and close the storage space; and a display part provided on the main body, in which the display part includes a substrate provided with a light source part for irradiating light; and a case in which the substrate is accommodated and forming an outer appearance, the case includes a display part which is opened on the front surface of the case and through which the light irradiated from the light source part passes; and a reflection part configured to extend from the circumference of the display part to the substrate to form a space in which the light source part is accommodated, and forming a surface on which the light irradiated from the light source part is reflected to face the display part; and a diffusion sheet configured to shield the display part is attached to a front surface of the case.

### TECHNICAL FIELD

The present disclosure relates to a refrigerator, and more particularly, to a display part for a refrigerator that externally displays various types of information regarding the operation of the refrigerator.

### BACKGROUND ART

In general, a refrigerator is a home appliance that can store food at a low temperature, and is configured to use cold air generated through heat exchange with a refrigerant circulating in a refrigeration cycle to cool a storage space so that the stored food can be stored in an optimal state.

In addition, the refrigerator is provided with a display part configure to display various information regarding the operation of the refrigerator, such as temperature and humidity of the storage space.

In general, the display part includes a substrate for processing inputted various information, a light source part including a light emitting device for irradiating light, a reflecting plate for reflecting the irradiated light, a diffusion sheet for diffusing the reflected light, and a front cover for transmitting the diffused light, and the front cover has a display part that indicates the operating state of the refrigerator and transmits light.

However, when the design of the display part is complicated, an assembly tolerance required for assembling the display part is small, so it is difficult to design the display part having a complicated design.

### DISCLOSURE

### Technical Problem

The present disclosure is to solve the above problems and an object of the present disclosure is to provide a refrigerator with an improved display part assembly structure that can be designed effectively even when a required assembly tolerance is small due to a complicated display part design.

More specifically, an object of the present disclosure is to provide a refrigerator in which the configuration of the display part is simplified by integrally providing an inclined part serving as a reflector in the front cover part.

In addition, an object of the present disclosure is to provide an assembly structure of the front cover and the substrate that can minimize the required mold.

### Technical Solution

In order to solve the above problems, an inclined part is provided to define an inner space of the display part and surround the outside of the light source part.

The inclined part can design the front cover part forming a reflection surface so that the light irradiated from the light source part is reflected to the outside of the display part, so that the display part can be effectively designed even when the required assembly tolerance is small due to the complicated design of the display part.

Since the front cover part is fixed to the substrate through thermal fusion, the front cover part can be stably fixed without adding a separate mold.

A refrigerator according to an embodiment of the present disclosure to solve the above problems may include a main body forming a storage space with an open front; a door configured to open and close the storage space; and a display part provided on the main body, in which the display part may include a substrate provided with a light source part for irradiating light; and a case in which the substrate is accommodated and forming an outer appearance, the case may include a display part which is opened on the front surface of the case and through which the light irradiated from the light source part passes; and a reflection part configured to extend from the circumference of the display part to the substrate to form a space in which the light source part is accommodated, and forming a surface on which the light irradiated from the light source part is reflected to face the display part; and a diffusion sheet configured to shield the display part may be attached to a front surface of the case.

The reflection part may be formed to be inclined from the substrate toward the front of the case.

The distance from the front end of the reflection part to the center of the light source part may be greater than the distance from the rear end of the reflection part to the center of the light source part.

A reflection material may be coated or attached to the reflection part.

The case may include a support part configured to protrude toward the substrate and to constrain through the substrate.

The support part may protrude backward from the front surface of the case between the plurality of reflection parts.

The end part of the support part may protrude through the substrate hole formed in the substrate, and a protruding end part may be heat-fused and fixed to the rear surface of the substrate.

The support part may include a supporting stand extending between the inclined parts and supporting the front surface of the substrate; a rib configured to protrude from the supporting stand and to penetrate the substrate; and a fixing part formed at an end part of the rib and fixed to a rear surface of the substrate.

A cross-sectional area of the rib may be formed to be smaller than an end part area of the supporting stand in contact with the substrate.

The fixing part may be formed by heat-fusing a part of the rib protruding through the substrate.

The case may include a front surface on which the display part and the reflection part are formed; and a circumferential part extending rearward along the circumference of the front surface, and the substrate may be accommodated inside the substrate formed by the front surface and the circumferential part.

Mounting parts extending so that the display part is mounted in the storage space may be formed on both sides of the circumferential part.

The substrate may be provided with a touch switch, a pressing part which is pressed by the user may be formed on the front surface of the case at a position corresponding to the touch switch, and the diffusion sheet may shield both the display part and the pressing part.

The display part may be exposed when the door is opened and may be shielded when the door is closed.

The display part may be provided inside the storage space, a front surface of the display part may be exposed as an open front surface of the storage space, and both surfaces of the display part in the left and right direction may be in contact with both internal surfaces of the storage space in the left and right direction.

### Advantageous Effect

According to the embodiment of the present disclosure having the above configuration, it is possible to provide a refrigerator with an improved display part assembly structure that can be effectively designed even when the required assembly tolerance is small due to the complicated design of the display part.

More specifically, it is possible to provide a refrigerator with a simplified display part configuration by integrally including an inclined part serving as a reflector on the front cover part.

In addition, according to an object of the present disclosure, an assembly structure of the front cover and the substrate that can minimize the required mold can be provided.

### DESCRIPTION OF DRAWINGS

FIG. 1 is a perspective view illustrating an outer appearance of a refrigerator according to an embodiment of the present disclosure.

FIG. 2 is a perspective view for illustrating the outer appearance of the display part with respect to the configuration of the embodiment of the present disclosure.

FIG. 3 is an exploded view illustrating the display part with respect to the configuration of the embodiment of the present disclosure.

FIG. 4 is a cross-sectional view taken along 4-4′ of FIG. 2.

FIG. 5 is a view illustrating a state before the rib is inserted into the substrate according to the embodiment of FIG. 4.

FIG. 6 is an exemplary view illustrating a state where light is reflected by the front cover according to an embodiment of the present disclosure.

FIG. 7 is a cross-sectional view illustrating a configuration including a hook, with respect to the configuration of another embodiment of the present disclosure.

FIG. 8 is a cross-sectional view illustrating a configuration including a rear cover part according to another embodiment of the present disclosure.

### BEST MODE

Hereinafter, some embodiments of the present disclosure will be described in detail with reference to exemplary drawings. In adding reference numerals to the components of each drawing, it should be noted that the same components are given the same reference numerals as much as possible even though they are indicated on different drawings. In addition, in describing the embodiment of the present disclosure, if it is determined that a detailed description of a related known configuration or function interferes with the understanding of the embodiment of the present disclosure, the detailed description thereof will be omitted.

In describing the components of the embodiment of the present disclosure, terms such as first, second, A, B, (a), and (b) may be used. These terms are only for distinguishing the component from other components, and the essence, order, or sequence of the component is not limited by the term. When it is described that a component is “connected”, “coupled” or “accessed” to another component, It will be understood that the component may be directly connected or assessed to the other component, but another component may be “connected”, “coupled” or “accessed” between each component.

In addition, it cannot be said that the spirit of the present disclosure is limited to the presented embodiments, and other embodiments included within the scope of the spirit of the present disclosure can be easily proposed by adding, changing, or deleting other components. In other words, in the embodiment of the present disclosure, a refrigerator in which a display is provided in the main body is described as an example for convenience of understanding and description, but the present disclosure is not limited thereto, and it should be noted in advance that all configuration in which the display is formed in the refrigerator are applicable.

In addition, in the following description, ‘front’ means a door direction of the refrigerator 1, that is, a direction in which the user faces the refrigerator 1.

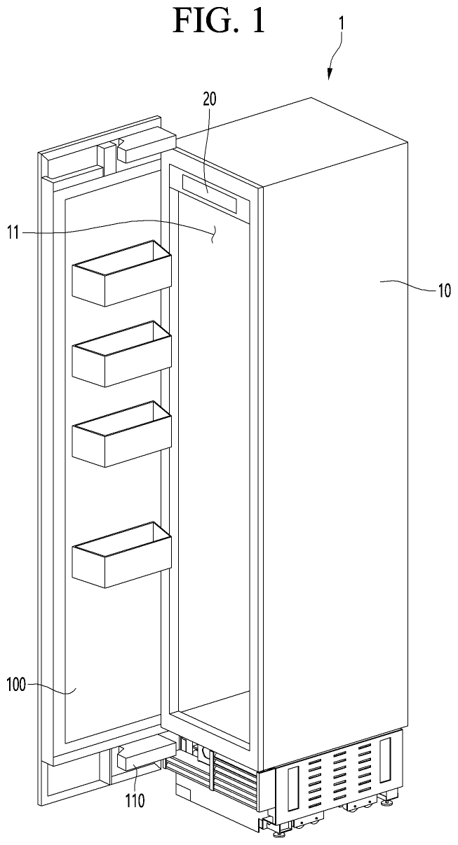

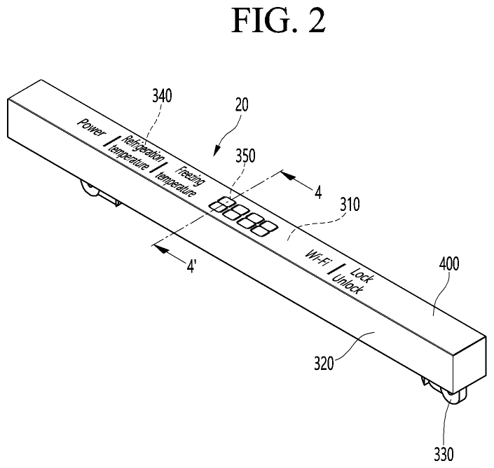

FIG. 1 is a perspective view illustrating an outer appearance of a refrigerator according to an embodiment of the present disclosure, and FIG. 2 is a perspective view for illustrating the outer appearance of the display part with respect to the configuration of the embodiment of the present disclosure.

Referring to the drawings, a refrigerator 1 according to an embodiment of the present disclosure includes a main body 10, a door 100 provided on the front of the main body 10, and a display part 20 provided on the main body 10.

A storage space 11 in which food for storage is accommodated is formed inside the main body 10. For example, the inside of the storage space 11 may be partitioned to form independent spaces, respectively.

The door 100 is rotatably mounted to the main body 10. The door 100 may further include a hinge assembly 110 connected to the door 100 to enable the door 100 to rotate from the body 10.

For example, the hinge assembly 800 may be a multi-joint hinge assembly including a plurality of links.

The display part 20 is provided on the front surface of the main body 10.

Various information of the refrigerator is displayed on the front surface of the display part 20 exposed to the outside. For example, information such as temperature and humidity of the storage space of the refrigerator is displayed.

The display part 20 may be mounted inside the storage space 11 of the main body 10. In addition, in a state where the display part 20 is mounted, both ends of the display part 20 may be in contact with both surfaces of the storage space 11. In addition, the front of the display part 20 may be exposed to the outside of the storage space 11 and may display operation information of the refrigerator to the outside. In addition, the front surface of the display part 20 may be located on the same plane as the front surface of the main body 10. In addition, the display part 20 may be exposed in a state where the door 100 is opened, and the display part 20 with the door 100 closed may be shielded. The display part 20 may be referred to as a display device.

Hereinafter, the display part 20, which is a main component of the present disclosure, will be described.

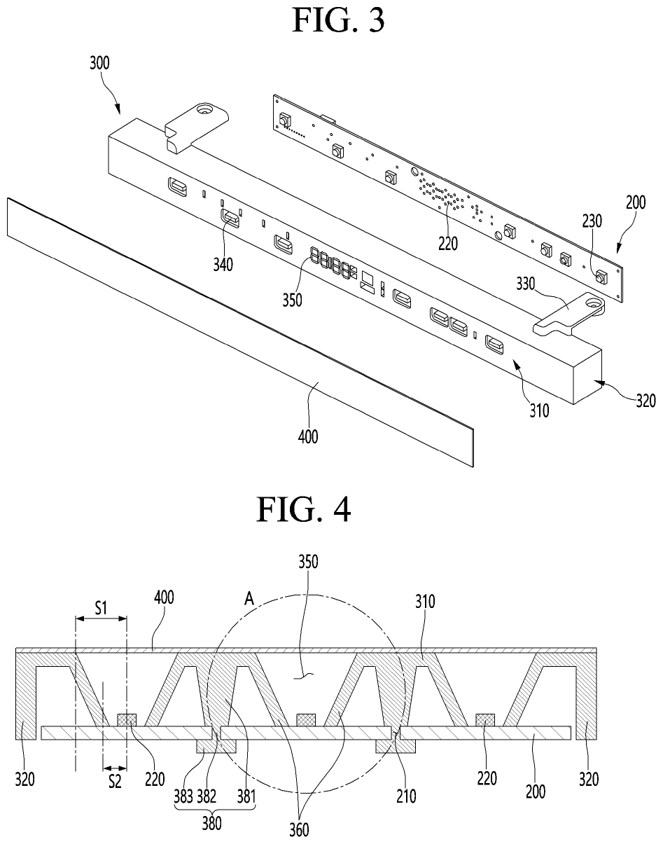

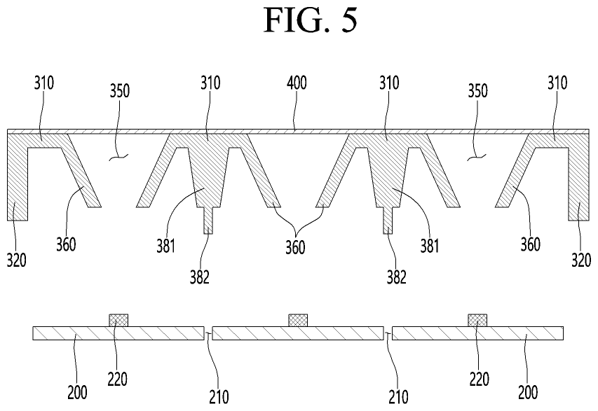

FIG. 3 is an exploded view illustrating the display part with respect to the configuration of the embodiment of the present disclosure, FIG. 4 is a cross-sectional view taken along 4-4′ of FIG. 2, and FIG. 5 is a view illustrating a state before the rib is inserted into the substrate according to the embodiment of FIG. 4.

Referring to the drawings, the display part 20 includes a substrate 200, a front cover part 300, and a diffusion sheet 400.

The substrate 200 may form a rear surface of the display part 20 in a plate shape of a predetermined size. The substrate 200 receives and processes various manipulation signals for the operation of the display part 20. The substrate 200 is provided with, for example, a system for processing various information for temperature adjustment of the freezing chamber and the refrigerating chamber, schedule management, memos, and the like.

The substrate 200 may be a printed circuit board assembly (PCBA, 200). The PCBA may include a touch PCB, a display PCB, or the like and may be configured in the form of at least one module.

In addition, the substrate 200 may include a substrate hole 210 formed through the substrate 200. A rib 382 to be described later may be inserted into the substrate hole 210 to be caught.

The light source part 220 is provided to protrude from the upper surface of the substrate 200. The light source part 220 may irradiate light to express various types of information based on a manipulation signal input to the substrate 200.

Accordingly, the light source part 220 may be formed of a plurality of light emitting devices. One or more light emitting devices may be arranged to be electrically connected to the upper surface of the substrate 200, and a plurality of light emitting devices may be disposed to be spaced apart from each other.

Here, the light emitting device may be, for example, a light emitting diode (LED). The light emitting diode includes a white LED, a red/green/blue LED, a blue LED, and a light emitting device emitting white light using a phosphor.

A plurality of the touch switches 230 are provided to protrude from the upper surface of the substrate 200. The substrate 200 may be manipulated through the touch switch 230. Specifically, the user may operate the touch switch 230 through the input part 340 to be described later to manage various information for temperature adjustment of the freezing chamber and the refrigerating chamber, schedule management, memos, and the like. In other words, an input for manipulation of the refrigerator may be possible by a user touching and manipulating the front surface of the display part 20.

The substrate 200 is provided inside the front cover part 300.

The front cover part 300 may include a front cover front surface 310 and a front cover circumferential part 320 to form the shape of a frame with an open rear.

The front cover part 300 may be positioned in front of the substrate 200 to accommodate the substrate 200 therein. In other words, the front cover part 300 may form the entire outer appearance including the front surface of the display part 20 exposed to the front surface of the refrigerator. In addition, the rear surface of the display part 20 may be formed by the substrate 200 accommodated in the front cover part 300.

The front cover part 300 may form the overall outer appearance shape of the display part. Accordingly, the front cover part 300 may be referred to as a case. In addition, the front cover part 300 may be formed to be larger than the substrate 200 so that the substrate 200 can be accommodated therein. In other words, the front cover part 300 may have a structure in which the substrate 200 is mounted therein while forming the outer appearance of the display part 20.

The front cover front surface 310 is spaced apart from the substrate 200 by a predetermined distance and is positioned in front of the substrate 200.

An input part 340 and a display part 350 may be provided on the front surface of the front cover front surface 310.

The input parts 340 are respectively formed at positions corresponding to the plurality of touch switches 230. The user may manage various information for temperature adjustment of the freezing chamber and the refrigerating chamber, schedule management, memos, and the like through the input part 340.

The display part 350 is formed to penetrate the front cover front surface 310. Accordingly, the light irradiated from the light source part 220 through the display part 350 may be irradiated to the outside of the display part 20.

Information such as temperatures of the freezing chamber and the refrigerating chamber is displayed through the display part 350. To this end, the display part 350 may be designed to have the shape of at least one or more letters, numbers, symbols, or the like indicating the operating state of the refrigerator and may be formed through the front cover front surface 310. As an example, the display part 350 may be formed in at least one 7-segment shape to represent numbers.

The front cover circumferential part 320 is formed to surround the front cover front surface 310 and thus the inner space of the front cover part 300 is formed.

A front cover supporting stand 330 may be provided on the front cover circumferential part 320 so that the display part 20 may be coupled to the inside of the storage space 11. In addition, the front cover supporting stand 330 may be referred to as a mounting part because the display part 20 can be mounted on the main body 10.

The front cover part 300 includes an inclined part 360 and a support part 380.

The inclined part 360 defines an inner space of the display part 350 and is provided to surround the outside of the light source part 220.

In addition, the inclined part 360 is extended obliquely toward the outer surface of the front cover front surface 310 from the substrate 200 to form a reflection surface on which the light irradiated from the light source part 220 is reflected to the outside of the display part 350. The inclined part 360 may be referred to as a reflection part or reflector because the light irradiated from the light source part 220 is reflected.

In other words, the front end part of the inclined part 360 is connected to the front cover front surface 310, and the rear end part of the inclined part 360 is located on the upper surface of the substrate 200.

A plurality of inclination parts 360 may be provided to correspond to each of the plurality of light source parts 220 and may be positioned to surround the light source part 220.

Since the inclined part 360 defines the inner space of the display part 350, when viewed from the front of the refrigerator, the inclined part 360 may be in the form of a channel for accommodating the light source part 220. Accordingly, the light irradiated from the light source part 220 is directed forward only through the space formed by the inclination part 360 and is irradiated to the outside through the display part 350 to display information.

The light source part 220 surrounded by the inclined part 360 may include a plurality of light emitting devices according to the design of the display part 350.

In addition, the inclined part 360 is configured to open toward the outer surface of the front cover front surface 310 from the substrate 200 to form a reflection surface on which the light irradiated from the light source part 220 is reflected to the outside of the display part 350.

Since the inclined part 360 extends obliquely from the substrate toward the outer surface of the front cover part, the inclined part may have a truncated conical shape.

Accordingly, the cross-sectional area of the front end part of the space formed by the inclined part 360 may be larger than the cross-sectional area of the rear end part of the space formed by the inclined part 360.

Also, referring to FIG. 4, the distance S1 from the front end part of the inclined part 360 to the center of the light source part 220 may be formed larger than the distance S2 from the rear end part of the inclined part 360 to the center of the light source part 220.

The inclined part 360 forms an inclined reflection surface to reflect the light irradiated from the light source part 220. Accordingly, light irradiated from the light emitting device of the light source part 220 through the inclination part 360 can be reflected without loss.

The reflection surface may be coated with a reflection material (for example, Ag) or a reflective sheet may be attached to the reflection surface. It may be composed of a metallic material (for example, Al, Ag, or a mixture thereof) having good thermal conductivity and reflectance. Alternatively, a material such as Ag may be plated or coated on the surface of the reflector or may be attached as a sheet.

By forming a reflection surface by placing the inclined part 360 on the front cover part 300 without a separate reflective plate, even when the design of the display part 350 is complicated and assembly tolerance is small, the display part 20 can be designed effectively.

In addition, since the display part 350 and the inclined part 360 are integrally formed with the front cover part 300, the light irradiated from the light source part 220 can be guided at the same time as the outer appearance of the display part 20 is formed. Accordingly, the configuration for guiding the light irradiated from the light source part 220 and the configuration for forming the outer appearance of the display part 20 are separately configured and do not need to be combined with each other, thereby reducing unnecessary work man-hours and thus it is possible to prevent assembly tolerances that may inevitably occur in a structure in which the shape of the part displayed by light passing through is complicated.

The support part 380 extends toward the substrate from the rear surface of the front cover front surface 310 and is located on the upper surface of the substrate 200. The front cover front surface 310 may be stably supported through the support part 380.

In addition, the support part 380 may include a supporting stand 381 and a rib 382 formed at one end of the supporting stand 381.

The supporting stand 381 may be in the form of a pillar extending from the front cover front surface 310 to support the front cover front surface 310. For example, the supporting stand 381 is formed in the form of a conical pillar that becomes thicker toward the front cover front surface 310, so that the front cover front surface 310 can be supported more stably.

The rib 382 may be formed to protrude from one end of the supporting stand 381.

The rib 382 is inserted into the substrate hole 210, and accordingly, the front cover part 300 is fixed to the substrate 200, so that the front cover front surface 310 can be supported more stably. The rib 382 may be formed to be smaller than the substrate hole 210 to be inserted into the substrate hole 210.

In detail, the supporting stand 381 may extend rearward from the front surface of the front cover part 300, and the extended end part may support the front surface of the substrate 200. In this case, the area of the end part of the supporting stand 381 in contact with the substrate 200 is larger than the cross-sectional area of the rib 382. Accordingly, in a state where the rib 382 is inserted into the substrate hole 210, the end part of the supporting stand 381 fixes the front surface of the substrate 200, the rib 382 penetrates the substrate 200, and thus the substrate 200 may be constrained.

Due to such a structure, the substrate 200 can be secured to be fixed with the front cover part 300, and the substrate 200 can maintain an accurate position without flowing inside the front cover part 300. Accordingly, it is possible to ensure that the light source part 220 is correctly positioned in the space inside the display part 350 and the inclination part 360 and can display information in an accurate form by irradiating light at an accurate position.

Also, the rib 382 may be inserted into the substrate hole 210 and thermally fused to be fixed to the substrate 200.

For example, the rib 382 inserted into the substrate hole 210 may be pressurized and then thermally fused to form the locking jaw 383. Specifically, the locking jaw 383 may be formed by pressing the rib 382 exposed to the bottom surface of the substrate 200 through the substrate hole 210 and then thermally fusing to the bottom surface of the substrate 200. Accordingly, the locking jaw 383 may be caught on the bottom surface of the substrate 200 to fix the front cover part 300. In addition, the locking jaw 383 may be referred to as a fusion part or a fixing part.

When the rib 382 protruding to the rear of the substrate 200 in a state where the rib 382 penetrates the substrate hole 210 constrains the rear surface of the substrate 200 by heat fusion, the substrate 200 may be constrained to flow in the front and rear direction. In other words, the front surface of the substrate 200 may be constrained by the supporting stand 381 inside the front cover part 300, and the rear surface may be constrained by the locking protrusion 383.

Due to this structure, the position of the substrate 200 can be completely fixed inside the front cover part 300, and in particular, a state where the rear end part of the inclined part 360 is in contact with the substrate 200 so as to be in close contact with the substrate 200 can be maintained. Accordingly, the light from the light source part 220 does not leak between the inclined part 360 and the substrate 200 and can be irradiated only through the inside of the space formed by the inclined part 360. In addition, the front cover part 300 and the substrate 200 can be fixed very simply and firmly.

In particular, the support part 380 may be disposed between the inclined parts 360 positioned at adjacent positions, and thus the close contact between the inclined part 360 and the substrates 200 in the area where light is irradiated from the light source part 220 may be further ensured.

The diffusion sheet 400 is provided to be laminated on the front cover front surface 310. Specifically, the diffusion sheet 400 is provided to cover the entirety corresponding to the front cover front surface 310.

The diffusion sheet 400 evenly diffuses the light irradiated from the light source part 220 through the display part 350 to uniformly illuminate the light transmitted to the outside. In addition, since the diffusion sheet 400 prevents the illumination brightness from being changed according to the distance from the light emitting device, light efficiency can be improved even with a small number of light emitting devices.

The diffusion sheet 400 is manufactured separately from the front cover part 300 and is attached to the front cover front surface 310. In this case, the diffusion sheet 400 may be formed to shield both the display part 350 and the input part 340. Accordingly, in a state where the light source part 220 is not turned on, the input part 340 and the display part 350 may be shielded so that they do not appear, and a front outer appearance of the display part 20 may be formed. In addition, the color of the transmitted light may be different by applying a different color of the diffusion ink to the diffusion sheet 400.

Hereinafter, an operation of the display part according to an embodiment of the present disclosure will be described with reference to the drawings.

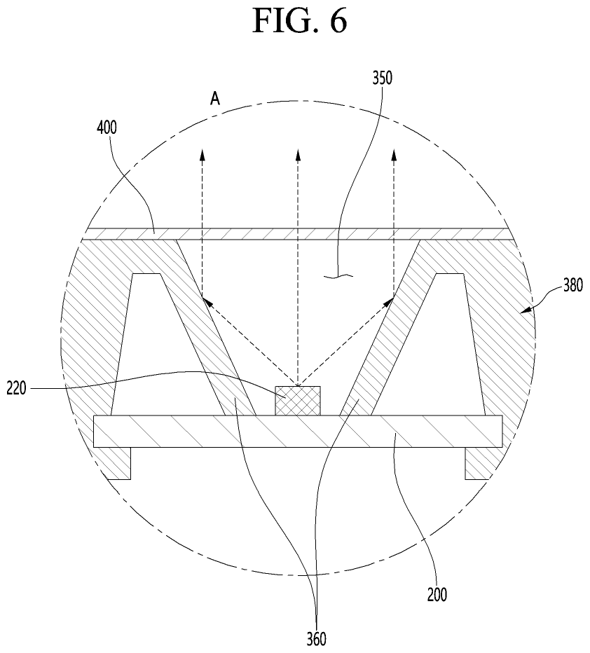

FIG. 6 is an exemplary view illustrating a state where light is reflected by the front cover according to an embodiment of the present disclosure.

Referring to the drawings, light is irradiated from the light source part 220 provided on the substrate 200, and the light may be transmitted to a plurality of surfaces defining the inclined part 360.

As described above, the plurality of surfaces may be surface-treated to facilitate light reflection, or light may be reflected more effectively by coating, film attachment, or printing.

Accordingly, light is reflected through the inclined part 360, and the reflected light is transmitted to the diffusion sheet 400.

The light transmitted to the diffusion sheet 400 is uniformly diffused in illuminance through the diffusion sheet 400 to be transmitted to the outside and displayed to the user.

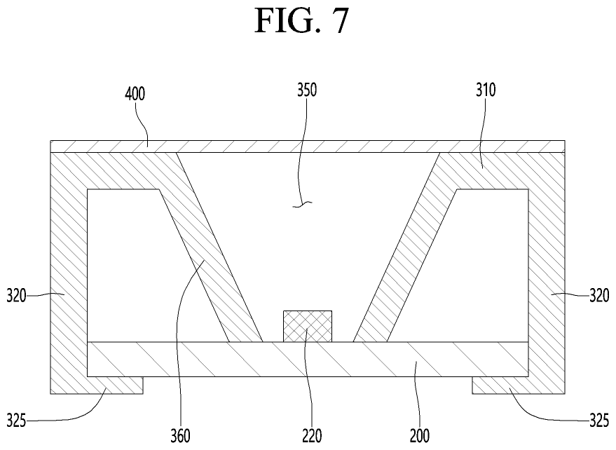

FIG. 7 is a cross-sectional view illustrating a configuration including a hook, with respect to the configuration of another embodiment of the present disclosure.

Referring to FIG. 7, the display part 20 includes a substrate 200, a front cover part 300, and a diffusion sheet 400. For the description of these, the description and reference numerals relating to the first embodiment are used.

The substrate 200 is provided inside the front cover part 300.

The front cover part 300 may include a front cover front surface 310 and a front cover circumferential part 320 to form the shape of a frame with an open rear.

The front cover part 300 may be positioned in front of the substrate 200 to accommodate the substrate 200 therein. In other words, the front cover part 300 may form the entire outer appearance including the front surface of the display part 20 exposed to the front surface of the refrigerator. In addition, the rear surface of the display part 20 may be formed by the substrate 200 accommodated in the front cover part 300.

The front cover part 300 may be formed to be larger than the substrate 200 so that the substrate 200 can be accommodated therein.

The front cover circumferential part 320 is formed to surround the front cover front surface 310 and thus the inner space of the front cover part 300 is formed.

A hook 325 is provided at an end part of the front cover circumferential part 320 to be caught on the bottom surface of the substrate 200. Accordingly, the substrate 200 may be fixed inside the front cover part 300.

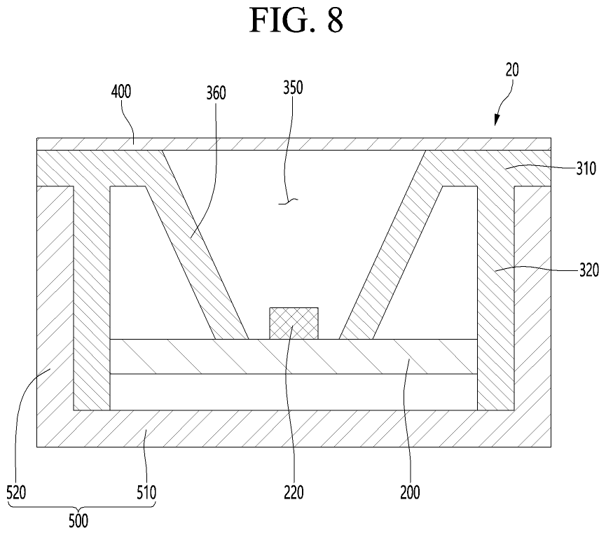

FIG. 8 is a cross-sectional view illustrating a configuration including a rear cover part according to another embodiment of the present disclosure.

Referring to FIG. 8, the display part 20 includes a substrate 200, a front cover part 300, a diffusion sheet 400, and a rear cover part 500. For the description of these, the description and reference numerals relating to the first embodiment are used.

The front cover part 300 is located on the front surface of the substrate 200 (based on the refrigerator).

The front cover part 300 may include a front cover front surface 310 and a front cover circumferential part 320 to form the shape of a frame with an open rear.

The front cover part 300 may be positioned in front of the substrate 200 to accommodate the substrate 200 therein.

The front cover part 300 may be formed to be larger than the substrate 200 so that the substrate 200 can be accommodated therein.

The front cover front surface 310 is provided to cover the front end of the front cover circumferential part 320 and is formed to be larger than the front surface formed by the front cover circumferential part 320. Accordingly, a rear cover side surface 520, which will be described later, may be in surface contact with the front cover circumferential part 320 and may be in contact with the rear surface of the front cover front surface 310 to support the front cover part 300.

The rear cover part 500 is combined with the front cover part 300 to form an internal space, and thus, the substrate 200 may be accommodated in the internal space.

The rear cover part 300 includes a rear cover rear surface 510 forming the rear surface of the display part 20 and a rear cover circumferential part 520 extending from the circumference of the rear cover rear surface 510 toward the front thereof.

The rear cover rear surface 510 forms a rear surface of the display part 20 and the substrate 200 is positioned above the rear cover rear surface 510.

As an example, a mold for supporting the substrate 200 may be added to the front surface of the rear cover rear surface 510.

The rear cover circumferential part 520 is formed to extend from the circumference of the rear cover rear surface 510 toward the front to form an inner space of the rear cover part 500. The substrate 200 may be accommodated in the inner space.

The rear cover circumferential part 520 may be in surface contact with the front cover circumferential part 320 and may be in contact with the rear surface of the front cover front surface 310 to support the front cover part 300.

Meanwhile, the refrigerator according to an embodiment of the present disclosure includes a main body in which a storage space is formed; and a display part provided on the main body, in which the display part includes a substrate provided with a light source part; a front cover part provided on the substrate and forming a display part through which light irradiated from the light source part passes; and a diffusion sheet that is provided on the front cover part and evenly diffuses the light irradiated from the light source part.

The front cover part defines an inner space of the display part and includes an inclined part provided to surround the outside of the light source part.

The inclined part extends obliquely from the substrate toward the outer surface of the front cover part to form a reflection surface through which light irradiated from the light source part is reflected to the outside of the display part.

In addition, the inclined part may be configured to spread from the substrate toward the outer surface of the front cover part.

For example, the front cover part is coupled to the front surface of the substrate, the inclined part extends from the front surface of the front cover toward the front surface of the substrate, and the distance from the front end part of the inclined part to the center of the light source part may be greater than the distance from read end part of the inclined part to the center of the light source part.

In addition, the inclined part may have a truncated conical shape, and the cross-sectional area of the front end part of the inclined part may be larger than the cross-sectional area of the rear end part of the inclined part.

A plurality of the inclined parts may be provided on the front cover part, and the front cover part may further include a support part provided between the plurality of inclined parts and coupled to the substrate.

In this case, the substrate includes a substrate hole formed through the substrate, the support part includes a supporting stand extending from the rear surface of the front cover front surface and disposed on the front surface of the substrate; and a rib protruding from one end of the supporting stand, in which the rib may be inserted into the substrate hole.

The rib may be heat-fused to the substrate hole.

In another embodiment of the present disclosure, the front cover part is bent and extends along the circumference of the upper surface of the front cover and may further include a front cover circumferential part forming an inner space of the front cover part in which the substrate is accommodated.

In another embodiment of the present disclosure, the front cover circumferential part may include a hook at an end part thereof, and the hook may be formed to be caught on the bottom surface of the substrate.

In another embodiment of the present disclosure, the display part further includes a rear cover part coupled to the front cover part, the rear cover part includes a rear cover rear surface forming the rear surface of the display part; and a rear cover circumferential part that is bent and extended along the circumference of the rear cover rear surface, in which the front cover circumferential part and the rear cover circumferential part may be coupled in surface contact with each other.

### INDUSTRIAL APPLICABILITY

The refrigerator according to the embodiment of the present disclosure has a simple configuration of the display part and improved assembly ability, so that industrial applicability will be high.

1. A refrigerator comprising:
a body configured to form a storage space;
a door configured to open and close the storage space; and
a display device provided on the body,
wherein the display device includes:
a substrate to support a light source part for irradiating light; and
a case to accommodate the substrate and provide an outer appearance,
wherein the case includes:
a display part having an opening on a front surface of the case, and configured to pass the light irradiated from the light source part passes; and
a reflection part configured to extend from the opening of the display part to the substrate so as to form a space to accommodate the light source part, and configured to provide a surface to face the display part and to reflect the light irradiated from the light source part; and
wherein a diffusion sheet to couple to a front surface of the case, and configured to shield the display part.

2. The refrigerator of claim 1,
wherein the reflection part is to be inclined from the substrate toward the front surface of the case.

3. The refrigerator of claim 1,
wherein a distance from a front end of the reflection part to a center of the light source part is greater than a distance from a rear end of the reflection part to a center of the light source part.

4. The refrigerator of claim 1,
wherein a reflection material is provided on the reflection part.

5. The refrigerator of claim 1,
wherein the reflection part includes a plurality of reflection parts,
wherein the case includes a support configured to protrude toward the substrate and to constrain the substrate.

6. The refrigerator of claim 5,
wherein the support protrudes backward from the front surface of the case between two adjacent ones of the plurality of reflection parts.

7. The refrigerator of claim 5,
wherein a protruding end part of the support protrudes through a substrate hole in the substrate, and
wherein the protruding end part is heat-fused and fixed to a rear surface of the substrate.

8. The refrigerator of claim 5,
wherein the support includes;
a supporting stand extending between two adjacent ones of the plurality of reflection parts and supporting the substrate;
a rib to protrude from the supporting stand and to penetrate the substrate; and
a fixing part at an end of the rib, and to be fixed to a rear surface of the substrate.

9. The refrigerator of claim 8,
wherein a cross-sectional area of the rib is to be smaller than an end part area of the supporting stand in contact with the substrate.

10. The refrigerator of claim 8,
wherein the fixing part is formed by heat-fusing part of the rib that penetrates through the substrate.

11. The refrigerator of claim 1,
wherein the case includes:
the front surface on which the display part and the reflection part are provided; and
a circumferential part to extend rearward from the front surface of the case, and
wherein the substrate is accommodated inside the case formed by the front surface and the circumferential part.

12. The refrigerator of claim 11,
wherein the case includes mounting parts extending from the circumferential part for mounting the display device at the storage space.

13. The refrigerator of claim 1,
wherein a touch switch is provided on the substrate,
wherein a pressing part to be pressed by a user, is provided on the front surface of the case at a position corresponding to the touch switch, and
wherein the diffusion sheet is configured to shield both the display part and the pressing part.

14. The refrigerator of claim 1,
wherein the display device is exposed when the door is opened, and the display device is shielded when the door is closed.

15. The refrigerator of claim 1,
wherein the display device is provided inside the storage space,
wherein a front surface of the display device is exposed as an open front surface of the storage space, and
wherein both surfaces of the display device in the left and right directions are in contact with both internal surfaces of the storage space in the left and right directions.

16. The refrigerator of claim 11,
wherein the case includes a hook at an end of the circumferential part, and wherein the hook is configured to couple to a rear surface of the substrate.

17. The refrigerator of claim 16,
wherein, when the hook is coupled to the rear surface of the substrate, a rear end of the reflection part is supported on the front surface of the substrate to constrain the substrate.

18. The refrigerator of claim 11,
wherein the substrate is to be in contact with an inner surface of the circumferential part and to shield an open rear surface of the display device.

19. A refrigerator comprising:
a body configured to provide a storage space;
a door configured to open and close the storage space; and
a display device provided on the body,
wherein the display device includes:
a light source configured to irradiate light;
a substrate to support the light source;
a front cover configured to provide an outer appearance of the display device, and to include a display part on a front surface of the front cover to transmit the light irradiated from the light source;
a diffusion sheet provided on the front cover and configured to shield the display part; and
a rear cover coupled to the front cover to form an inner space in which the substrate is accommodated, and
wherein the front cover extends from the display part to the substrate and includes a reflection part to face the display part and configured to reflect the light irradiated from the light source.

20. The refrigerator of claim 19,
wherein the front cover includes:
a front cover front surface on which the display part and the reflection part are provided; and
a front cover circumferential part extending from the front cover front surface to the rear cover,
wherein the substrate to be in contact with an inner surface of the front cover circumferential part and the reflection part, and
wherein the rear cover shields an open rear surface of the front cover.
